(19) United States
(12) Patent Application Publication
(10) Pub. No.: US 2025/0296331 A1
(43) Pub. Date: Sep. 25, 2025

(54) LIQUID EJECTION HEAD AND LIQUID EJECTION APPARATUS

(71) Applicant: RISO Technologies Corporation, Tokyo (JP)

(72) Inventor: Shinichiro HIDA, Mishima Shizuoka (JP)

(21) Appl. No.: 19/019,255

(22) Filed: Jan. 13, 2025

(30) Foreign Application Priority Data
Mar. 25, 2024 (JP) 2024-047972

(51) Int. Cl. B41J 2/14; B41J 2/175

(52) U.S. Cl. CPC B41J 2/14274; B41J 2/1433; B41J 2/175; B41J 2002/14419; B41J 2002/14491

(57) ABSTRACT

A liquid ejection head includes a nozzle plate including a plurality of nozzles from which liquid is ejected, a first substrate facing the nozzle plate and in which a plurality of pressure chambers each communicating with a corresponding one of the nozzles are formed, and a first vibrating plate on the first substrate, forming walls of the pressure chambers, and capable of vibrating to cause the liquid to be ejected from each of the nozzles independently. The first vibrating plate includes a central part at which the walls of the pressure chambers are formed and a pair of thin-wall parts by which the central part is sandwiched, a thickness of the thin-wall parts being smaller than that of the central part.

### CROSS-REFERENCE TO RELATED APPLICATION

This application is based upon and claims the benefit of priority from Japanese Patent Application No. 2024-047972, filed on Mar. 25, 2024, the entire contents of which are incorporated herein by reference.

### FIELD

Embodiments described herein relate generally to a liquid ejection head and a liquid ejection apparatus.

### BACKGROUND

A liquid ejection head, such as an inkjet head, is used in a system in which a vibrating plate is deformed using an actuator formed of a piezoelectric body such as lead zirconate titanate (PZT) to thereby deform a pressure chamber facing the vibrating plate to eject liquid from a nozzle communicated with the pressure chamber. The liquid ejection head has a plurality of actuators, vibrating plates which transmit the vibrations from the actuators, and a flow channel member which forms a plurality of pressure chambers facing the vibrating plates and flow channels communicated with the pressure chambers. For example, when forming such pressure chambers and flow channels communicating with the pressure chambers by bonding the vibrating plates and the flow channel member to each other, it is required to ensure proper sealing between the vibrating plates and the flow channel member, and therefore, it is common to provide the vibrating plate with the same outer shape as that of the flow channel member.

### BRIEF DESCRIPTION OF THE DRAWINGS

FIG. 1 is a cross-sectional view showing a configuration of an inkjet head according to a first embodiment.

FIG. 2 is a cross-sectional view showing a configuration of the inkjet head

FIG. 3 is a cross-sectional view showing a configuration of the inkjet head.

FIG. 4 is an exploded perspective view showing a configuration of the inkjet head.

FIG. 5 is a perspective view showing a configuration of the inkjet head.

FIG. 6 is a diagram illustrating a stack structure of an end portion of a vibrating plate of the inkjet head.

FIG. 7 is a diagram illustrating a schematic configuration of an inkjet printing apparatus.

FIG. 8 is an exploded perspective view showing a configuration of an inkjet head according to a second embodiment.

FIG. 9 is a perspective view showing a configuration of the inkjet head.

FIG. 10 is an exploded perspective view showing a configuration of an inkjet head according to a third embodiment.

FIG. 11 is a plan view showing a configuration of the inkjet head.

FIG. 12 is a cross-sectional view showing a configuration of the inkjet head.

### DETAILED DESCRIPTION

Embodiments of this disclosure provide a liquid ejection head and a liquid ejection apparatus capable of reducing the manufacturing cost.

In general, according to one embodiment, a liquid ejection head comprises a nozzle plate including a plurality of nozzles from which liquid is ejected, a first substrate facing the nozzle plate and in which a plurality of pressure chambers each communicating with a corresponding one of the nozzles are formed, and a first vibrating plate on the first substrate, forming walls of the pressure chambers, and capable of vibrating to cause the liquid to be ejected from each of the nozzles independently. The first vibrating plate includes a central part at which the walls of the pressure chambers are formed and a pair of thin-wall parts by which the central part is sandwiched, a thickness of the thin-wall parts being smaller than that of the central part.

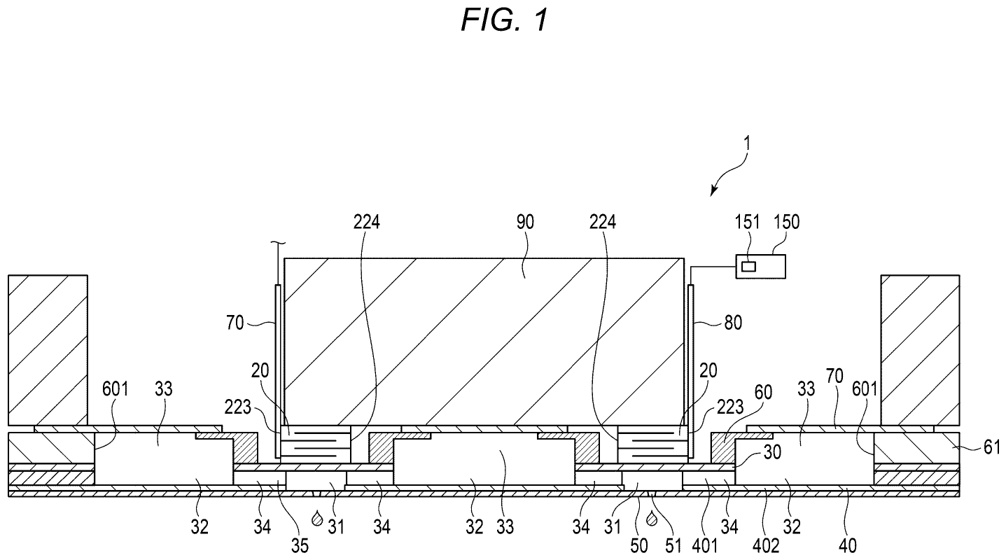

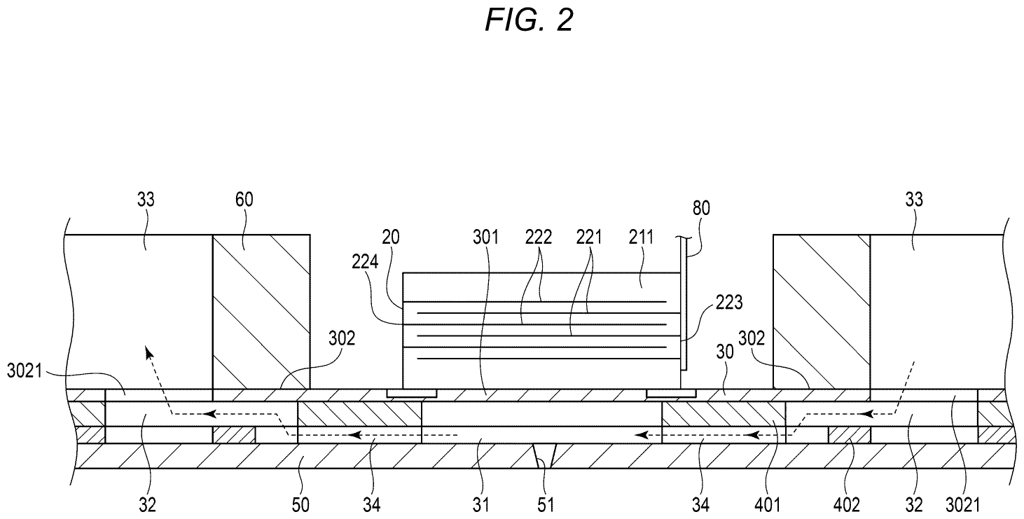

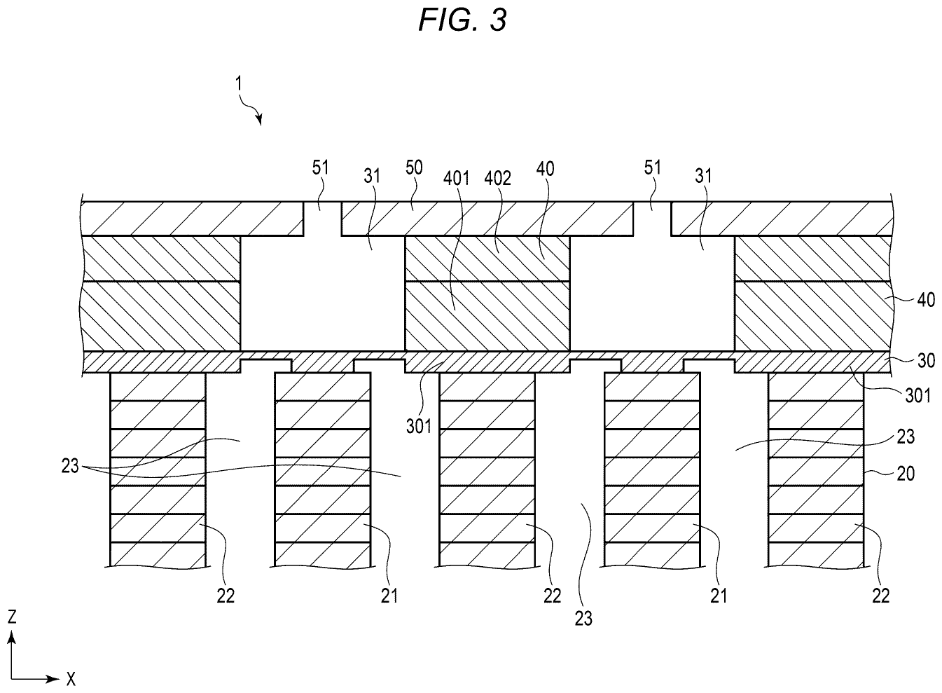

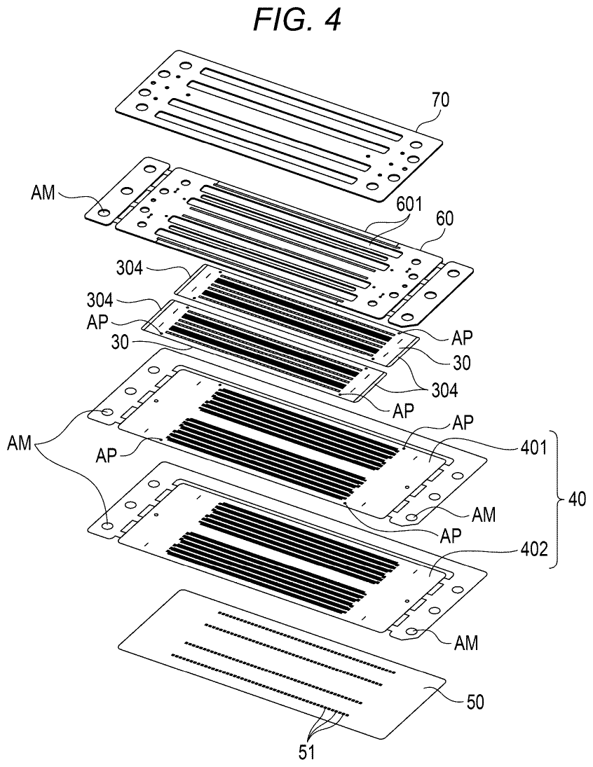

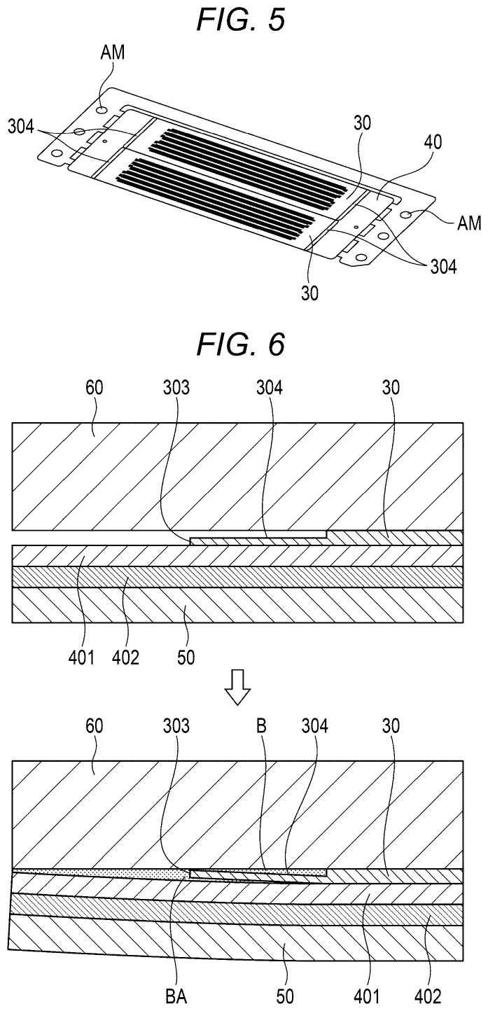

An inkjet head 1 which is a liquid ejection head according to a first embodiment and an inkjet printing apparatus 100 which is a liquid ejection apparatus will hereinafter be described with reference to FIG. 1 through FIG. 7. FIG. 1, FIG. 2, and FIG. 3 are each a cross-sectional view showing a configuration of the inkjet head 1. FIG. 4 is an exploded perspective view showing a configuration of a flow channel structure unit of the inkjet head 1. FIG. 5 is a perspective view showing a configuration of the flow channel structure unit of the inkjet head 1. FIG. 6 is an explanatory diagram showing a stack structure of an end portion of a vibrating plate with an opposed member. In the drawings, arrows X, Y, and Z respectively represent three directions perpendicular to each other. Here, X-axis is parallel to the arrangement direction of nozzles 51 and pressure chambers 31, Y-axis is parallel to the extending direction thereof, and Z-axis is parallel to the opposed direction and the axial direction of the nozzle. In the drawings, the constituents are shown with expansion, contraction, or omission as appropriate for the sake of convenience of explanation.

As shown in FIG. 1 to FIG. 6, the inkjet head 1 is provided with actuator units 20, a vibrating plate 30, a flow channel member 40 as an opposed member, a nozzle plate 50, a manifold plate 60 as an opposed member, a damper film 70, and a drive circuit 80.

For example, the inkjet head 1 is formed by stacking the nozzle plate 50, the flow channel member 40, one or more vibrating plates 30, the actuator units 20, the manifold plate 60, and the damper film 70 in this order.

As an example of the inkjet head 1, there is shown an example in which a vibration direction of a piezoelectric element 21 and a vibration direction of the vibrating plate 30 are each parallel to the Z direction. In the present example, the flow channel structure unit which forms an ink flow channel 35 inside the inkjet head 1 is configured with the vibrating plate 30, the flow channel member 40, the manifold plate 60, and the damper film 70 at a reverse side of the nozzle plate 50. The inkjet head 1 is of a circulation type in which the liquid is circulated in predetermined flow channels.

For example, the inkjet head 1 is a head with a four-column integral structure having four columns of actuator units 20 and four nozzle arrays. In the present embodiment, two vibrating plates 30 are arranged so as to be opposed with respect to the flow channel member 40 and the manifold plate 60 as the opposed members. In the inkjet head 1, positions of nozzles 51 in the four nozzle arrays are arranged so as to be shifted to different positions in a parallel direction.

The plurality of actuator units 20 include driving piezoelectric elements 21 as a plurality of actuators and a plurality of non-driving piezoelectric elements 22 which are formed of, for example, piezoelectric members, and which are alternately arranged along a column direction. Here, the nozzles 51 are disposed so as to be opposed to the center in the extending direction of the actuator unit 20, and the actuator unit 20 has a structure in which one side and the other side are symmetric centering on the nozzles 51. For example, the actuator units 20 are bonded to a base 90 having a rectangular shape. The actuator unit 20 is disposed so as to be opposed to the vibrating plate 30, and generates pressure in the pressure chamber 31.

In the actuator unit 20, the plurality of driving piezoelectric elements 21 and the plurality of non-driving piezoelectric elements 22 are arranged at regular intervals in the parallel direction. For example, the plurality of driving piezoelectric elements 21 and the plurality of non-driving piezoelectric elements 22 are all configured to have rectangular solid columnar shapes the same in outer shape. The actuator unit 20 is divided into a plurality of parts with, for example, a plurality of grooves 23, and the plurality of driving piezoelectric elements 21 and the plurality of non-driving piezoelectric elements 22 are arranged in the column direction at the same pitch with, for example, the grooves 23 having the same width.

For example, the plurality of driving piezoelectric elements 21 and the plurality of non-driving piezoelectric elements 22 are each configured to have a rectangular shape the transverse direction of which is parallel to the column direction of the element column, and the longitudinal direction of which is parallel to an extending direction (i.e., the Y direction) of the pressure chamber 31 perpendicular to the column direction and the stacking direction (i.e., the Z direction) in a plan view viewed from the Z direction which is an axial direction of the nozzle 51.

The driving piezoelectric elements 21 are arranged at positions respectively opposed to the plurality of pressure chambers 31 provided to the flow channel member 40 in the Z direction. For example, the center position in the column direction and the extending direction of the driving piezoelectric element 21 and the center position in the column direction and the extending direction of the pressure chamber 31 are arranged side by side in the Z direction.

The non-driving piezoelectric elements 22 are arranged at positions respectively opposed to wall parts provided to the flow channel member 40 in the Z direction. For example, the center position in the column direction and the extending direction of the non-driving piezoelectric element 22 and the center position in the column direction and the extending direction of the wall part are arranged side by side in the Z direction.

For example, the stack type piezoelectric member constituting the actuator unit 20 is formed by stacking sheet-like piezoelectric materials, and then sintering the piezoelectric materials. In the actuator unit 20, by performing dicing processing on the stacked type piezoelectric member from one end surface to thereby form the grooves 23, the plurality of piezoelectric elements formed to have the rectangular columnar shapes are formed at predetermined intervals. Then, electrodes and so on are provided to the plurality of columnar elements thus formed, and thus, the plurality of driving piezoelectric elements 21 and the plurality of non-driving piezoelectric elements 22 arranged alternately are formed. The plurality of driving piezoelectric elements 21 and the plurality of non-driving piezoelectric elements 22 are alternately arranged in parallel to each other across the grooves 23 in the column direction.

The piezoelectric member constituting the driving piezoelectric element 21 and the non-driving piezoelectric element 22 is, for example, a stacked piezoelectric body. The driving piezoelectric element 21 and the non-driving piezoelectric element 22 are provided with a plurality of piezoelectric body layers 211 stacked on one another, and internal electrodes 221, 222 formed on principal surfaces of each of the piezoelectric body layers 211. For example, the driving piezoelectric element 21 and the non-driving piezoelectric element 22 have the same stacked structure. Further, the driving piezoelectric element 21 and the non-driving piezoelectric element 22 are provided with external electrodes 223, 224 each formed on a surface.

The piezoelectric body layer 211 is formed of the piezoelectric material such as a lead zirconate titanate (PZT) based piezoelectric material or a lead-free potassium sodium niobate (KNN) based piezoelectric material.

The internal electrodes 221, 222 are conductive films formed of a conductive material which can be sintered such as silver-palladium to have a predetermined shape. The internal electrodes 221, 222 are respectively coupled to the external electrodes 223, 224 formed on side surfaces of the piezoelectric elements 21, 22.

The external electrodes 223, 224 are formed on the surfaces of the plurality of driving piezoelectric elements 21 and the plurality of non-driving piezoelectric elements 22, and are formed by collecting end portions of the internal electrodes 221, 222.

For example, the external electrode 223 is defined as an individual electrode, and the external electrode 224 is defined as a common electrode. Each of the external electrodes 223, 224 is coupled to a control unit 150 via a driver IC of the drive circuit 80, and is configured so that drive control can be performed. The arrangement of the common electrode and the individual electrode may be reversed.

The driving piezoelectric element 21 vibrates when a voltage is applied to the internal electrodes 221, 222 via the external electrodes 223, 224. Here, the driving piezoelectric element 21 makes a longitudinal vibration along the stacking direction of the piezoelectric body layers 211. The longitudinal vibration mentioned here means, for example, a “vibration in the thickness direction defined by a piezoelectric constant d33”. The driving piezoelectric element 21 displaces the vibrating plate 30 with the longitudinal vibration to deform the pressure chamber 31. In other words, the actuator unit 20 is disposed so as to be opposed to the vibrating plate 30, and generates pressure in the pressure chamber 31.

The vibrating plate 30 extends along a plane perpendicular to the Z direction as the vibration direction, and is bonded to a surface at one side, namely the nozzle plate 50 side, in the stacking direction which is the vibration direction of the piezoelectric body layers 211 of the plurality of piezoelectric elements 21, 22. The vibrating plate 30 is opposed to the plurality of nozzles 51 via the pressure chambers 31 in the Z direction as the vibration direction. The vibrating plate 30 is, for example, deformable. The vibrating plate 30 is bonded to the driving piezoelectric elements 21 and the non-driving piezoelectric elements 22 of the actuator unit 20.

In the inkjet head 1, two vibrating plates 30 are disposed to the four columns of actuator units 20. In other words, two columns of actuator units 20 are provided to each of the vibrating plates 30.

For example, the vibrating plate 30 is disposed so as to be stacked at the other side in the stacking direction of the flow channel member 40 to constitute a part of the ink flow channel 35. For example, the vibrating plate 30 includes a vibration area 301 opposed to the actuator unit 20, and a support area 302 to be bonded to the flow channel member 40 in an outer peripheral part of the vibration area 301. For example, the vibration area 301 forms a wall at an opposite side to an ejection side of the pressure chamber 31 in the opposed direction.

An outer circumferential edge of the vibrating plate 30 has a thin-wall part 304, which retracts inward from an outer circumferential edge of the opposed member disposed so as to be opposed thereto in the stacking direction, and is smaller in thickness dimension in the stacking direction than a central portion, in at least a partial region. For example, the vibrating plate 30 is larger than a region where the pressure chamber array is formed and is smaller than an outer shape of the flow channel member 40 when viewed from the stacking direction (i.e., the opposed direction). The thin-wall part 304 is disposed at an outer side of a region opposed to, for example, the actuator unit 20 in the vibrating plate 30.

For example, each of the vibrating plates 30 is formed so that the width in the Y direction perpendicular to the Z direction is larger than the width of the pressure chamber formation region where the two pressure chamber arrays are disposed, and the length in the X direction is longer than the length in the X direction of the pressure chamber formation region.

Meanwhile, the vibrating plate 30 is smaller than the flow channel member 40 when viewed from the Z direction. For example, the vibrating plate 30 has the thin-wall part 304, which is thinner in wall thickness than the central portion, in both end portions 303 in the X direction in the outer circumferential edge. The thin- wall part 304 is a half-cut part which is formed to have a thin thickness by, for example, half cutting. The vibrating plate 30 is disposed so as to partially be stacked at the other side in the stacking direction of the flow channel member 40 to constitute a part of the ink flow channel 35. For example, the thin-wall part 304 is partially removed in an area opposed to the manifold plate 60. In other words, a step is provided to the end portion 303 in the X direction of the vibrating plate 30, and there is created a positional relationship in which an outer edge of the surface at the manifold plate 60 side retracts inward from the outer edge of the surface at a flow channel substrate 401 side.

The vibration area 301 has a plate shape disposed so that, for example, the thickness direction becomes the vibration direction of the piezoelectric body layers 211. A surface direction of the vibrating plate 30 extends in the arrangement direction of the plurality of driving piezoelectric elements 21 and the plurality of non-driving piezoelectric elements 22. The vibrating plate 30 is, for example, a metal plate.

For example, the vibrating plate 30 is formed of nickel or an SUS plate, and the thickness dimension along the vibration direction is in a range of about 5 um to 15 um, and the vibrating plate 30 has a thickness dimension of 10 um, for example. A region disposed so as to be opposed to the driving piezoelectric element 21 is displaced due to expansion and contraction of the driving piezoelectric element 21, and thus, the vibration area 301 deforms. For example, the vibrating plate 30 is required to have an extremely thin and complicated shape, and is therefore formed by an electroforming method or the like. The vibrating plate 30 is joined to an upper end surface of the actuator unit 20 with bonding or the like. In the vibration area 301, a crease or a step may be formed in a region adjacent to the vibrating region or between the vibrating regions adjacent to each other so as to facilitate the displacement of the plurality of vibrating regions.

The support area 302 is disposed so as to be opposed to the flow channel member 40 in the stacking direction. For example, an opening part 3021 which forms a flow channel communicating a first common liquid chamber 32 and a second common liquid chamber 33 with each other may be formed in a region which is included in the support area 302 of the vibrating plate 30, and is located between, for example, the manifold plate 60 and the flow channel substrate 401.

The flow channel member 40 has a plurality of flow channel substrates 401, 402. The flow channel member 40 is bonded to one side of the vibrating plate 30 to form the plurality of pressure chambers 31 and the first common liquid chamber 32.

The flow channel member 40 may be formed with an integrated member, or may be formed of a plurality of flow channel substrates stacked on one another. For example, in accordance with viscosity of the ink, a volume of the ink to be ejected, and so on, the plurality of flow channel substrates 401, 402 having opening parts or grooves, the nozzle plate 50, and the vibrating plate 30 are bonded to each other in combination with each other to form the desired ink flow channel 35. The plurality of flow channel substrates 401, 402 are disposed so as to be stacked on one another in the stacking direction, and the predetermined ink flow channel 35 including a coupling flow channel 34 and the pressure chambers 31 is formed with the openings or the grooves provided to each of the flow channel substrates 401, 402. For example, the flow channel substrates 401, 402 are disposed so as to be stacked on one another in series from the vibrating plate 30 side, and the flow channel substrate 401 is disposed so as to be opposed to the vibrating plate 30, and the flow channel substrate 402 is disposed so as to be opposed to the nozzle plate 50.

The flow channel member 40 is disposed between the nozzle plate 50 and the vibrating plate 30. The predetermined ink flow channel 35 including the plurality of pressure chambers 31, the first common liquid chamber 32, and a plurality of coupling flow channels 34 which reach the pressure chambers 31 from the first common liquid chamber 32 is formed inside the flow channel member 40 by the plurality of flow channel substrates being stacked on one another and then bonded to each other. In other words, the flow channel member 40 forms, by the stacked plurality of flow channel substrates, a surrounding wall part surrounding the plurality of pressure chambers 31 and the plurality of coupling flow channels 34, a plurality of wall parts for partitioning the columns of the plurality of pressure chambers 31, a plurality of wall parts for partitioning the plurality of coupling flow channels 34, and a surrounding wall part forming the first common liquid chamber 32.

As shown in FIG. 1 and FIG. 2, the flow channel member 40 is disposed so as to be opposed to the vibrating plate 30 in the stacking direction, and is bonded to the vibrating plate 30. The flow channel member 40 is provided with a plurality flow channel substrates 401, 402 having outer shapes larger than that of the vibrating plate 30, and each of the flow channel substrates 401,402 is formed of a metal material including SUS430 as an example, or a resin material such as silicone. The flow channel substrates 401, 402 are each provided with opening parts for forming the pressure chambers 31, the coupling flow channels 34, and the first common liquid chamber 32. For example, the flow channel substrate 401 as one of the flow channel substrates is provided with the opening parts for forming the pressure chambers 31 and the first common liquid chamber 32, and the flow channel substrate 402 as the other of the flow channel substrates is provided with the opening parts for forming the pressure chambers 31, the coupling flow channels 34, and the first common liquid chamber 32.

In other words, in the flow channel member 40, the plurality of pressure chambers 31, the coupling flow channels 34, and the first common liquid chamber 32 are formed by the opening parts of the plurality of flow channel substrates 401, 402 which are arranged side by side in the stacking direction and are communicated with each other.

The plurality of pressure chambers 31 are spaces formed at one side of the vibration area 301 of the vibrating plate 30, and each of the pressure chambers 31 is communicated with the nozzle 51 provided to the nozzle plate 50. Further, the pressure chamber 31 is covered by the vibrating plate 30 at an opposite side to the nozzle plate 50.

The plurality of pressure chambers 31 are communicated with the first common liquid chamber 32 through the coupling flow channel 34. The pressure chamber 31 retains the liquid supplied through the first common liquid chamber 32 and the coupling flow channel 34, and ejects the liquid from the nozzle 51 in response to the deformation of the pressure chamber 31 due to the vibration of the vibrating plate 30 constituting a part of the pressure chamber 31.

The first common liquid chamber 32 is a flow channel communicated with the end portion in the flow direction of the plurality of coupling flow channels 34. For example, the first common liquid chambers 32 are respectively formed at both sides of the column of the pressure chambers 31 with the flow channel member 40.

The coupling flow channels 34 communicate the respective pressure chambers 31 and the first common liquid chamber 32 with each other, and extend in the Y direction which is the flow direction. The coupling flow channels 34 at the both sides are smaller in dimension in the width direction perpendicular to the extending direction which is the flow direction, and smaller in flow channel cross-sectional area, compared to the first common liquid chambers 32 and the pressure chambers 31.

The partition wall parts partitioning between the plurality of pressure chambers 31, the side wall parts partitioning between the plurality of coupling flow channels 34, and the surrounding wall part are formed of other regions than the opening parts of each of the flow channel substrates 401, 402.

A variety of alignment marks AM, AP for positioning the plate members 401, 402, 30, 50, 60, and 70 which are stacked on one another and then assembled with other members to be stacked are provided to each of the plate members 401, 402, 30, 50, 60, and 70. For example, the alignment marks AM, AP are formed of a line hole, a circular hole, and so on, and are disposed at positions overlapping the alignment marks AM, AP of other members to be disposed so as to be opposed thereto, or end portions of other members, and become indexes for positioning when assembling.

The nozzle plate 50 is formed like a rectangular plate which is made of metal such as SUS·Ni or a resin material such as polyimide, which has a thickness of about 10 μm through 100 μm. The nozzle plate 50 is disposed at one side of the flow channel member 40 so as to cover the opening at one side of the pressure chamber 31. The nozzle plate 50 includes the plurality of nozzles 51 for ejecting droplets. The plurality of nozzles 51 are hole parts which penetrate the nozzle plate 50 in the thickness direction. The plurality of nozzles 51 are arranged in the first direction the same as the arrangement direction of the pressure chambers 31 to form the nozzle array. The nozzles 51 are respectively disposed at positions corresponding to the plurality of pressure chambers 31.

The manifold plate 60 is a structure disposed on an outer peripheral part of the actuator unit 20. For example, the manifold plate 60 is a plate-like member formed of a metal material such as SUS to have a thickness of 0.6 mm to 1.2 mm. The manifold plate 60 may form a part of an outer frame of the inkjet head 1. Further, a flow channel of a liquid is formed inside the manifold plate 60. For example, the manifold plate 60 has a flow channel hole 601 for forming the second common liquid chamber 33 communicated with the first common liquid chamber 32 of the flow channel member 40. The manifold plate 60 has a frame part 61 which is disposed in the outer peripheral part of the vibrating plate 30, bonded to the flow channel member 40, and shaped like a frame. For example, the frame part 61 forms the second common liquid chamber 33.

The second common liquid chamber 33 is a space communicated with the first common liquid chamber 32 provided to the flow channel member 40. The second common liquid chamber 33 is formed inside the frame part 61, and is communicated with the pressure chambers 31 through the first common liquid chamber 32 and the coupling flow channels 34.

The damper film 70 is a film member formed of a resin material such as polyimide. The damper film 70 is disposed so as to be opposed thereto at an opposite side to the vibrating plate 30 of the manifold plate 60. For example, the damper film 70 closes an opening part of the manifold plate 60.

The drive circuit 80 is provided with a wiring film one end of which is coupled to the external electrodes 223, 224, a driver IC mounted on the wiring film, and a printed wiring board mounted on the other end of the wiring film.

The drive circuit 80 applies the drive voltages to the external electrodes 223, 224 with the driver IC to thereby drive the piezoelectric elements 21, and thus, increases or decreases the volumes of the pressure chambers 31 to eject droplets from the nozzles 51.

The wiring film is coupled to the plurality of external electrodes 223, 224. For example, the wiring film is an anisotropic conductive film (ACF) fixed to coupling portions of the external electrodes 223, 224 with thermocompression bonding. The wiring film is, for example, a chip on film (COF) on which the driver IC is mounted.

The driver IC is coupled to the external electrodes 223, 224 via the wiring film. The driver IC may be coupled to the external electrodes 223, 224 with other measures such as an anisotropic conductive paste (ACP), a nonconductive film (NCF), or a nonconductive paste (NCP) instead of the wiring film.

The driver IC generates control signals and drive signals for operating the piezoelectric elements 21. The driver IC generates the control signals for control such as selecting the timing of ejecting the ink and selecting the piezoelectric element 21 which ejects the ink in accordance with an image signal input from the control unit 150 of the inkjet printing apparatus 100. Further, the driver IC generates the voltages to be applied to the piezoelectric elements 21, namely the drive signals, in accordance with the control signals. When the driver IC applies the drive signal to the piezoelectric element 21, the piezoelectric element 21 performs driving so as to displace the vibrating plate 30 to change the volume of the pressure chamber 31. Thus, a pressure vibration occurs in the ink with which the pressure chamber 31 is filled. Due to the pressure vibration, the ink is ejected from the nozzle 51 provided to the pressure chamber 31. It is possible for the inkjet head 1 to be able to realize gradation expression by changing an amount of an ink droplet to be landed in one pixel. Further, it is possible for the inkjet head 1 to be able to change the amount of the ink droplet to be landed in one pixel by changing the number of times of ejection of the ink.

For example, the driver IC is provided with a data buffer, a decoder, and drivers. The data buffer saves the print data for each of the piezoelectric elements 21 in a time-series manner. The decoder controls the driver based on the print data saved in the data buffer for each of the piezoelectric elements 21. The drivers output the drive signals for making the respective piezoelectric elements 21 operate based on the control of the decoder. The drive signals are, for example, voltage signals to be applied to the respective piezoelectric elements 21.

The printed wiring board is a printing wiring assembly (PWA) on which a variety of electronic components and connectors are mounted. The printed wiring board is coupled to the control unit 150 of the inkjet printing apparatus 100.

When assembling the flow channel structure unit in the inkjet head 1 configured as described above, first, as shown in FIG. 4, the nozzle plate 50, the flow channel substrates 402, 401 forming the flow channel member 40, the vibrating plates 30, the manifold plate 60, and the damper film 70 are stacked on one another, an adhesive is supplied to predetermined bonding areas including the outer peripheral parts between the members, and then these members thus stacked are pressurized to form the flow channel structure unit. On this occasion, the positioning of the plurality of plate members 50, 401, 402, 30, 60, and 70 can be achieved by performing the image recognition of the plurality of marks AM, PM and the positions of the end portions of the members which function as reference positions. Then, the actuator units 20 in the state of being bonded to the base 90 is arranged in the opening part provided to the flow channel structure unit, then disposed so as to be opposed to the vibrating plates 30, and then bonded thereto to thereby assemble the actuator units 20 to the flow channel structure unit.

The inkjet head 1 is provided with a bonded part B in which the thin-wall part 304 of the vibrating plate 30, the manifold plate 60, and the flow channel member 40 are bonded to each other with an adhesive BA. Further, in the bonded part B, the flow channel member 40 and the manifold plate 60 are bonded to each other via an adhesive at an outer side of the outer circumferential edge of the vibrating plate 30.

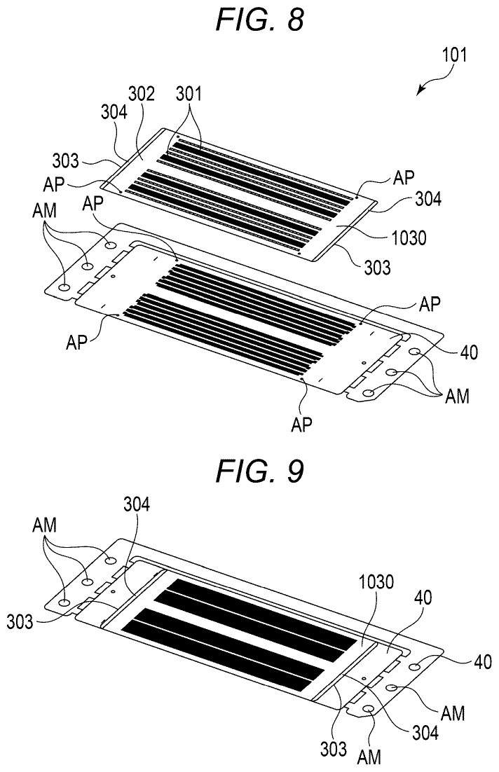

For example, as shown in FIG. 8, when the nozzle plate 50, the flow channel substrates 402, 401 forming the flow channel member 40, the vibrating plate 30, and the manifold plate 60 are stacked on one another with the adhesive BA supplied to the bonding areas between the plate members to be stacked on one another, and are then pressed in the stacking direction, the plurality of plate members 50, 401, 402, 30, 60, and 70 are bonded to each other via the adhesive. For example, the bonded areas are set to outer edge portions at the outer side of the pressure chamber formation region or areas between the regions where the plurality of pressure chamber arrays are disposed.

Here, as shown in FIG. 8, the vibrating plate 30 is smaller than the outer shape of the flow channel substrate 401, and the both end portions in the X direction of the vibrating plate 30 are formed to be thin wall. Therefore, in the flow channel substrate 401 and the manifold plate 60 disposed across the vibrating plate 30, since the outer circumferential edge bends in the pressure direction, the flow channel substrate 401 and the manifold plate 60 are bonded to each other via the adhesive BA in the area at the outer side of the outer circumferential edge portion of the vibrating plate 30.

Since the manifold plate 60 is thick and rigid, the periphery of the vibrating plate 30 is pressurized toward the manifold plate 60 when bonding to gently deform the flow channel substrates 401, 402 so that the outer circumferential portions come closer to the manifold plate 60, and then the manifold plate 60, the vibrating plate 30, and the flow channel substrates 401, 402 are bonded to each other.

In this way, the flow channel structure unit which forms the ink flow channel 35 inside the inkjet head 1 is configured with the vibrating plate 30, the flow channel member 40, the manifold plate 60, and the damper film 70 at the reverse side of the nozzle plate 50. The ink flow channel 35 includes the plurality of pressure chambers 31 disposed at the positions corresponding in the stacking direction to the driving piezoelectric elements 21 of the actuator unit 20 across the vibrating plate 30, the coupling flow channels 34 disposed at both sides in the extending direction of the plurality of pressure chambers 31, the first common liquid chambers 32 continuing to the end portions in the extending direction of the plurality of coupling flow channels 34 at the both sides, and the second common liquid chamber 33.

The inkjet head 1 is of the circulation type, and for example, the first common liquid chamber 32 communicates with an ink tank 132, and the ink is supplied to the pressure chambers 31 through the first common liquid chamber 32 at the inflow side. All the piezoelectric elements 21 are coupled with wiring lines so that the voltages can be applied to the piezoelectric elements 21. In the inkjet head 1, when the control unit 150 applies the drive voltage to the electrodes 221, 222 with the driver IC, the piezoelectric element 21 as the driving target vibrates in the stacking direction, namely the thickness direction of the piezoelectric body layers 211. In other words, the piezoelectric element 21 makes a longitudinal vibration.

Specifically, the control unit 150 applies the drive voltage to the internal electrodes 221, 222 of the piezoelectric element 21 as the driving target to selectively drive the piezoelectric element 21 as the driving target. Then, the deformation in a tensile direction and the deformation in a compression direction due to the piezoelectric element 21 as the driving target are combined with each other to deform the vibrating plate 30 to change the volume of the pressure chamber 31 to thereby introduce the liquid from the first common liquid chamber 32, and then eject the liquid from the nozzle 51.

The ink supplied to the pressure chamber 31 is ejected from the nozzle 51, or collected in the ink tank 132 via the coupling flow channel 34 at the other side as the collection side, and the common liquid chambers 32, 33.

In the inkjet head 1, the ink circulates in the ink flow channel 35 using one side in the extending direction as the inflow side or the supply side, and the other side as outflow side or the collection side.

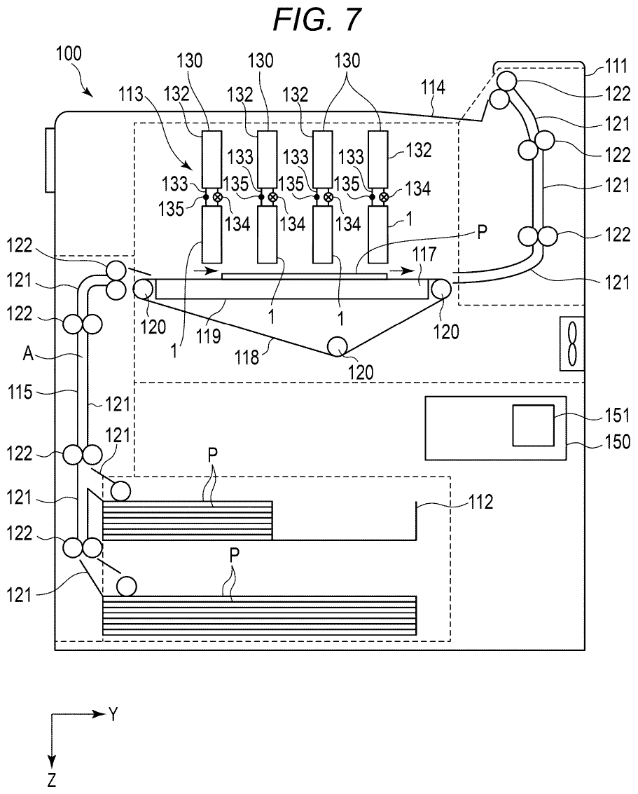

An example of the inkjet printing apparatus 100 equipped with the inkjet head 1 will hereinafter be described with reference to FIG. 7. The inkjet printing apparatus 100 is provided with a chassis 111, a medium supply unit 112, an image forming unit 113, a medium discharge unit 114, a conveyance device 115, and the control unit 150.

The inkjet printing apparatus 100 is a liquid ejection apparatus which ejects a liquid such as ink while conveying, for example, a sheet P as a print medium which is an ejection target along a predetermined conveyance path A from the medium supply unit 112 to the medium discharge unit 114 through the image forming unit 113 to thereby perform image forming processing on the sheet P.

The chassis 111 constitutes an outer frame of the inkjet printing apparatus 100. A discharge opening for discharging the sheet P outside is disposed at a predetermined position of the chassis 111.

The medium supply unit 112 is provided with a plurality of paper cassettes, and is able to hold a plurality of sheets P of a variety of sizes in a stacked manner.

The medium discharge unit 114 is provided with a catch tray to hold the sheet P discharged from the discharge opening.

The image forming unit 113 is provided with a holding unit 117 for holding the sheet P, and a plurality of head units 130 disposed above the holding unit 117 so as to be opposed to the holding unit 117.

The holding unit 117 is provided with a conveyance belt 118 provided to a predetermined area for performing the image formation to have a loop shape, a holding plate 119 for holding the conveyance belt 118 from a reverse side, and a plurality of belt rollers 120 provided at the reverse side of the conveyance belt 118.

When forming the image, the holding unit 117 holds the sheet P on a holding surface as an upper surface of the conveyance belt 118, and feeds the conveyance belt 118 at a predetermined timing due to a rotation of the belt rollers 120 to thereby convey the sheet P downstream.

The head units 130 are respectively provided with the plurality (e.g., four colors) of inkjet heads 1, ink tanks 132 as liquid tanks respectively mounted on the inkjet heads 1, coupling channels 133 for respectively coupling the inkjet heads 1 and the ink tanks 132 to each other, and supply pumps 134.

In the present example, there are provided the inkjet heads 1 of four colors, namely cyan, magenta, yellow, and black, and the ink tanks 132 for respectively containing the ink of these colors. The ink tanks 132 are coupled to the inkjet heads 1 with the coupling channels 133, respectively.

Further, to the ink tanks 132, there are connected negative pressure control devices such as pumps not shown. Further, by performing the negative pressure control on the inside of the ink tank 132 with the negative pressure control device in accordance with hydraulic head values of the inkjet head 1 and the ink tank 132, meniscus having a predetermined shape is provided to the ink supplied to each of the nozzles 51 of the inkjet head 1.

The supply pumps 134 are each a liquid feeding pump formed of, for example, a piezoelectric pump. The supply pumps 134 are disposed in the supply flow channels. The supply pumps 134 are coupled to the drive circuit of the control unit 150 with the wiring lines, and are controlled by a central processing unit (CPU). The supply pumps 134 each supply the inkjet head 1 with the liquid.

The conveyance device 115 conveys the sheet P along the conveyance path A from the medium supply unit 112 to the medium discharge unit 114 through the image forming unit 113. The conveyance device 115 is provided with a plurality of guide plate pairs 121 and a plurality of conveying rollers 122 arranged along the conveyance path A.

The plurality of guide plate pairs 121 are each provided with a pair of plate members arranged so as to be opposed to each other across the sheet P to be conveyed, and guide the sheet P along the conveyance path A.

The conveying rollers 122 are driven by the control unit 150 to rotate to thereby feed the sheet P downstream along the conveyance path A. Sensors for detecting conveyance state of the sheet are arranged at a variety of places on the conveyance path A.

The control unit 150 is provided with a control circuit 151 such as a CPU as a controller, a read only memory (ROM) for storing a variety of programs and so on, a random access memory (RAM) for temporarily storing a variety of variable data, image data, and so on, and an interface unit for performing input of data from the outside and output of data to the outside.

In the inkjet printing apparatus 100 configured as described above, when the control unit 150 detects a print instruction that is input by the user through, for example, the interface, the control unit 150 drives the conveyance device 115 to convey the sheet P, and outputs the print signals to the head units 130 at predetermined timing to thereby drive the inkjet heads 1. As the ejection operation, the inkjet head 1 transmits the drive signal to the driver IC using the image signal according to the image data to apply the drive voltage to the internal electrodes 221, 222 to selectively drive the piezoelectric element 21 as the ejection target to make the longitudinal vibration in the stacking direction to change the volume of the pressure chamber 31 to thereby eject the ink from the nozzle 51 to form the image on the sheet P held on the conveyance belt 118. Further, as the liquid ejection operation, the control unit 150 drives the supply pumps 134 to thereby supply the ink from the ink tanks 132 to the first common liquid chambers 32 of the inkjet heads 1, respectively.

Here, a drive operation of driving the inkjet head 1 will be described. The inkjet head 1 is provided with the piezoelectric elements 21 disposed so as to be opposed to the pressure chambers 31, and these piezoelectric elements 21 are coupled so that the voltage can be applied thereto with the wiring lines. The control unit 150 transmits the drive signal to the driver IC using the image signal according to the image data to apply the drive voltage to the internal electrodes 221, 222 of the piezoelectric element 21 as the driving target to selectively deform the piezoelectric element 21 as the driving target. Then, by combining the deformation in the tensile direction and the deformation in the compression direction of the vibrating plate 30 with each other to change the volume of the pressure chamber 31, the liquid is ejected.

For example, the control unit 150 alternately performs tension actions and compression actions. In the inkjet head 1, when performing the tension action of increasing the volume of the pressure chamber 31 as the target, the piezoelectric element 21 as the driving target is contracted while the piezoelectric elements which are not the driving target are not deformed. Further, in the inkjet head 1, when performing the compression action of decreasing the volume of the pressure chamber 31 as the target, the driving piezoelectric element 21 as the target is expanded, while the non-driving piezoelectric elements 22 are not deformed.

According to the inkjet head 1 and the inkjet printing apparatus 100 described above, since the vibrating plate 30 is smaller than the outer shape of the flow channel substrate 401, and includes the thin-wall parts 304 in the both end portions, it is possible to reduce the size of the vibrating plate 30 which is expensive while ensuring the adhesiveness, and thus, it is possible to suppress the manufacturing cost. That is, by dividing the vibrating plate 30 into the regions corresponding to the actuator units 20, it is possible to reduce the outer peripheral part which does not make a contribution to the vibration from the vibrating plate 30.

For example, as shown in FIG. 6, in the configuration in which the vibrating plate 30 is smaller than the flow channel substrate 401 and the manifold plate 60, a gap exists between the flow channel substrate 401 and the manifold plate 60. The adhesive layer is about 1 to 2 μm thick, but in order to fill the gap of 10 μm when the vibrating plate 30 is 10 μm thick, it is necessary to make the adhesive layer thicker, and it is difficult to ensure the sealing property. On the other hand, when making the adhesive layer thicker, deformation may occur during thermal curing in some cases, and therefore, it is desirable for the adhesive layer to be thin and uniform. Therefore, as described above, since the both end portions of the vibrating plate 30 are made thinner by half cutting, it is possible to narrow and then fill the gap due to the difference in size between the vibrating plate 30 and the opposed members such as the flow channel member 40 and the manifold plate 60 to prevent the ink leakage while keeping the adhesive layer thin and uniform, and thus, it is possible to realize downsizing of the vibrating plate 30.

Further, since the bonding is performed up to the supply flow channel in the transverse direction of the vibrating plate 30, the both end portions in the longitudinal direction which are most likely affected by the gap are targeted. Therefore, as described above, the thin-wall parts 304 are formed in the both end portions in the X direction as the longitudinal direction, and thus, the influence of the gap on the sealing property can effectively be reduced.

The present disclosure is not limited to the embodiments described above, and can be implemented with modifications of the constituents within the scope or the spirit of the present disclosure.

For example, in the embodiments described above, there is described the example in which the four columns of actuator units 20 and pressure chambers 31 are arranged, but this is not a limitation. For example, three or less, or five or more columns of nozzles 51 and pressure chambers 31 may be provided. Further, in the first embodiment described above, there is described the example in which the two vibrating plates 30 each corresponding the two columns of actuator units 20 are disposed for the four columns of actuator units 20, but this is not a limitation.

### Second Embodiment

A configuration of an inkjet head 101 according to a second embodiment will hereinafter be described with reference to FIG. 8 and FIG. 9. FIG. 8 is an explanatory diagram showing a configuration of a vibrating plate 1030 and the flow channel member 40 of the inkjet head 101, and shows an arrangement of the flow channel member 40 and the vibrating plate 1030. FIG. 9 is a cross-sectional view showing a configuration of the inkjet head 101. For example, the inkjet head 101 according to the second embodiment is provided with the single vibrating plate 1030 with respect to the four columns of actuator units 20 and the pressure chambers 31. The inkjet head 101 is a head with a four-column integral structure having four columns of actuator units 20 and four nozzle arrays. In the inkjet head 101, positions of nozzles 51 in the four nozzle arrays are arranged so as to be shifted to different positions in a parallel direction.

In the inkjet head 101, the single vibrating plate 1030 is disposed to the four columns of actuator units 20. That is, the pressure chamber formation region opposed to the vibrating plate 1030 is formed of the four actuator units 20.

For example, the vibrating plate 1030 is disposed so as to be stacked at the other side in the stacking direction of the flow channel member 40 to constitute a part of the ink flow channel 35. For example, the vibrating plate 1030 includes the vibration area 301 opposed to a pressure chamber formation part formed of the four actuator units 20, and the support area 302 to be bonded to the flow channel member 40 in an outer peripheral part of the vibration area 301. For example, the vibration area 301 forms a wall at an opposite side to the ejection side of the pressure chamber 31 in the opposed direction.

An outer circumferential edge of the vibrating plate 1030 has the thin-wall part 304, which retracts inward from an outer circumferential edge of the opposed member disposed so as to be opposed thereto in the stacking direction, and is smaller in thickness dimension in the stacking direction than a central portion, in at least a partial region. For example, the vibrating plate 1030 is larger than a region where the pressure chamber array is formed and is smaller than an outer shape of the flow channel member 40 when viewed from the stacking direction.

For example, the vibrating plate 1030 is configured so that the width in the Y direction perpendicular to the Z direction is larger than the width of the pressure chamber formation region where the four pressure chamber arrays are disposed, and the length in the X direction is longer than the length in the X direction of the pressure chamber formation region.

Meanwhile, the vibrating plate 1030 is smaller than the flow channel member 40 when viewed from the Z direction. For example, the vibrating plate 1030 has the thin-wall part 304, which is thinner in wall thickness than the central portion, in the end portions 303 at both sides in the X direction in the outer circumferential edge. The thin-wall part 304 is a half-cut part which is formed to have a thin thickness by, for example, half cutting. For example, the vibrating plate 1030 is disposed so as to partially be stacked at the other side in the stacking direction of the flow channel member 40 to constitute a part of the ink flow channel 35.

The rest of the configuration is substantially the same as that of the inkjet head 1 according to the first embodiment described above.

Also in the second embodiment, substantially the same advantages as those of the inkjet head 1 according to the first embodiment described above can be obtained. Specifically, since the vibrating plate 1030 is smaller than the outer shape of the flow channel substrate 401, and includes the thin-wall parts 304 in the both end portions, it is possible to reduce the size of the vibrating plate 1030 which is expensive while ensuring the adhesiveness, and thus, it is possible to suppress the manufacturing cost.

### Third Embodiment

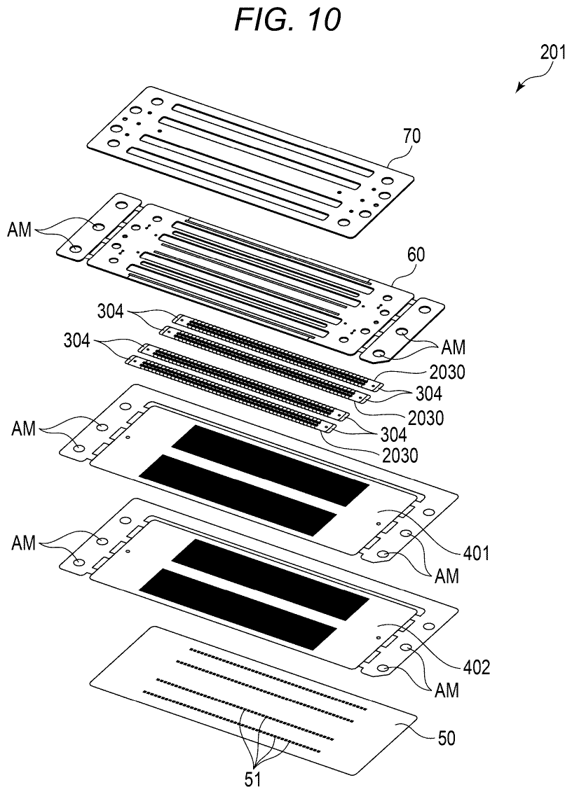

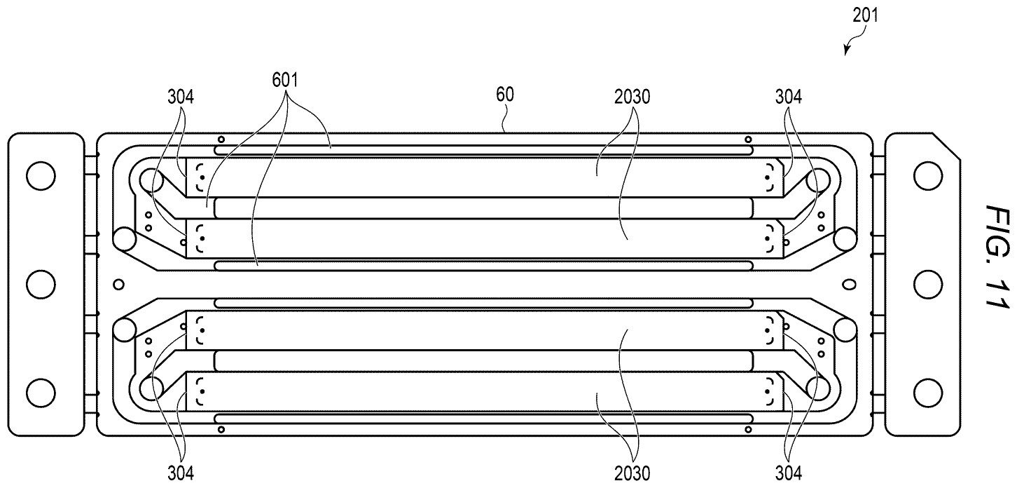

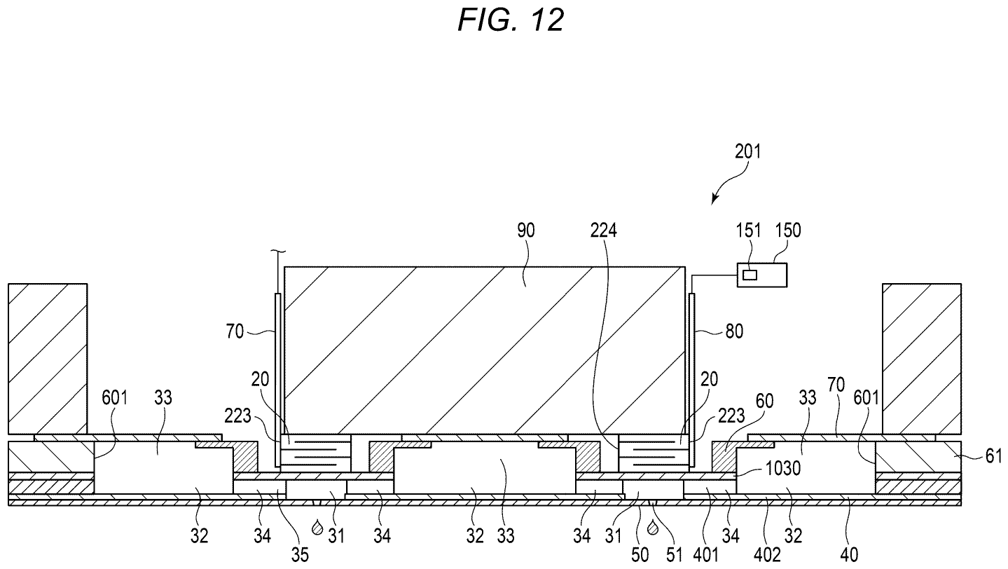

A configuration of an inkjet head 201 according to a third embodiment will hereinafter be described with reference to FIG. 10 to FIG. 12. FIG. 10 is an exploded perspective view showing a configuration of the inkjet head 201, and FIG. 11 and FIG. 12 are a plan view and a cross-sectional view each showing a configuration of the inkjet head 201. As shown in FIG. 10 to FIG. 12, the inkjet head 201 is provided with four vibrating plates 2030 to the four columns of actuator units 20 and the four columns of pressure chambers 31, and one vibrating plate 2030 is provided for each of the columns. The inkjet head 201 according to the present embodiment is a head with a four-column integral structure having four columns of actuator units 20 and four nozzle arrays. In the inkjet head 201, positions of nozzles 51 in the four nozzle arrays are arranged so as to be shifted to different positions in a parallel direction. In other words, the four columns of actuator units 20 are arranged so that the positions of the driving piezoelectric elements 21 and the positions of the non-driving piezoelectric elements 22 are slightly different in the parallel direction between the four columns of actuator units 20.

In the inkjet head 201, the four vibrating plates 2030 are disposed to the four columns of actuator units 20. That is, the inkjet head 201, in which the pressure chamber formation region opposed to the vibrating plate 2030 is formed of the single actuator unit 20, has the four pressure chamber formation regions.

For example, the vibrating plate 2030 is disposed so as to be stacked at one side in the stacking direction of the flow channel member 40 to constitute a part of the ink flow channel 35. For example, the vibrating plate 2030 includes the vibration area 301 opposed to each of the four pressure chamber formation parts formed of the four actuator units 20, and the support area 302 to be bonded to the flow channel member 40 in an outer peripheral part of the vibration area 301. For example, the vibration area 301 forms a wall at an opposite side to an ejection side of the pressure chamber 31 in the opposed direction.

An outer circumferential edge of the vibrating plate 2030 has the thin-wall part 304, which retracts inward from an outer circumferential edge of the opposed member disposed so as to be opposed thereto in the stacking direction, and is smaller in thickness dimension in the stacking direction than a central portion, in at least a partial region. For example, the vibrating plate 2030 is larger than a region where the pressure chamber array is formed and is smaller than an outer shape of the flow channel member 40 when viewed from the stacking direction.

For example, each of the vibrating plates 2030 is configured so that the width in the Y direction perpendicular to the Z direction is larger than the width of the pressure chamber formation region where the pressure chamber array is disposed, and the length in the X direction is longer than the length in the X direction of the pressure chamber formation region.

Meanwhile, the vibrating plate 2030 is smaller than the flow channel member 40 when viewed from the Z direction. For example, the vibrating plate 2030 has the thin-wall part 304, which is configured to be thinner in wall thickness than the central portion, in both end portions 303 in the X direction in the outer circumferential edge. The thin-wall part 304 is a half-cut part which is formed to have a thin thickness by, for example, half cutting. For example, the vibrating plate 2030 is disposed so as to partially be stacked at the other side in the stacking direction of the flow channel member 40 to constitute a part of the ink flow channel 35.

The rest of the configuration is substantially the same as those of the inkjet heads 1, 101 according to the first embodiment and the second embodiment described above.

Also in the third embodiment, substantially the same advantages as those of the inkjet heads 1, 101 according to the first embodiment and the second embodiment described above can be obtained. Specifically, since the vibrating plate 2030 is configured to be smaller than the outer shape of the flow channel substrate 401, and includes the thin-wall parts 304 in the both end portions, it is possible to reduce the size of the vibrating plate 2030 which is expensive while ensuring the adhesiveness, and thus, it is possible to suppress the manufacturing cost.

For example, the specific configuration of the flow channel member 40 is not limited to the above. For example, the flow channel substrate may be formed of a single member, or three or more flow channel substrates may be used. Further, the shapes of the opening parts in each of the flow channel substrates are also not limited to those in the embodiments described above.

For example, in the embodiments described above, there is adopted the configuration in which the plural layers of piezoelectric members are stacked on one another, and the piezoelectric elements 21 are driven using the longitudinal vibration (d33) in the stacking direction, but this is not a limitation. The present disclosure may be applied to, for example, an aspect in which the piezoelectric elements 21 are each formed of a single layer piezoelectric member, and may also be applied to an aspect of performing the drive with a transversal vibration (d31).

Further, the specific configurations of the piezoelectric elements 21, 22, the shapes of the flow channels, the configurations of and the positional relationship between the variety of components including the flow channel member 40, the nozzle plate 50, and the manifold plate 60 are not limited to the examples described above, but may be changed as appropriate. Further, the arrangements of the nozzles 51 and the pressure chambers 31 are not limited to the above. For example, the nozzles 51 may be arranged in two or more columns. Further, dummy chambers may be formed between the plurality of pressure chambers 31.

Further, the liquid to be ejected is not limited to the ink for printing, and it is possible to adopt, for example, an apparatus for ejecting the liquid including conductive particles for forming wiring patterns of a printed wiring board.

Further, in the embodiments described above, there is shown the example in which the inkjet head 1 is used in the liquid ejection apparatus such as the inkjet printing apparatus, but this is not a limitation. The inkjet head 1 may be used in, for example, a 3D printer, an industrial manufacturing machine, and medical purposes, and allow to reduce the size, the weight, and the cost.

According to at least one embodiment described hereinabove, it becomes possible to reduce the cost.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A liquid ejection head comprising:
a nozzle plate including a plurality of nozzles from which liquid is ejected;
a first substrate facing the nozzle plate and in which a plurality of pressure chambers each communicating with a corresponding one of the nozzles are formed; and
a first vibrating plate on the first substrate, forming walls of the pressure chambers, and capable of vibrating to cause the liquid to be ejected from each of the nozzles independently, wherein
the first vibrating plate includes a central part at which the walls of the pressure chambers are formed and a pair of thin-wall parts by which the central part is sandwiched, a thickness of the thin-wall parts being smaller than that of the central part.

2. The liquid ejection head according to claim 1, wherein
in a first direction along which the nozzles are arranged, a length of the first vibrating plate is shorter than a length of the first substrate and the nozzle plate.

3. The liquid ejection head according to claim 1, further comprising:
a second vibrating plate on the first substrate, wherein
the nozzles are arranged in a plurality of rows including first and second rows,
the first vibrating plate faces the nozzles in the first row, and
the second vibrating plate faces the nozzles in the second row.

4. The liquid ejection head according to claim 1, further comprising:
a manifold plate in which a flow channel of the liquid is formed, wherein
the first vibrating plate is sandwiched between the first substrate and the manifold plate.

5. The liquid ejection head according to claim 4, further comprising:
an adhesive layer between the manifold plate and the first substate at and outside each of the thin-wall parts of the first vibrating plate.

6. The liquid ejection head according to claim 4, wherein
in a first direction along which the nozzles are arranged, a length of the first vibrating plate is shorter than a length of the manifold plate.

7. The liquid ejection head according to claim 1, wherein
the nozzles are arranged in a first direction, and
each of the thin-wall parts extends in a second direction perpendicular to the first direction.

8. The liquid ejection head according to claim 1, wherein
the first substrate and the first vibrating plate form a plurality of flow channels that communicate with the pressure chambers.

9. The liquid ejection head according to claim 1, further comprising:
a plurality of piezoelectric elements each configured to vary pressure in a corresponding one of the pressure chambers, wherein
each of the piezoelectric elements contacts the wall of the corresponding pressure chamber.

10. The liquid ejection head according to claim 1, further comprising:
a second substrate between the nozzle plate and the first substate and forming flow channels through which the liquid can flow from common liquid chambers to the pressure chambers.

11. A liquid ejection apparatus comprising:
a conveyer configured to convey a medium; and
a liquid ejection head configured to eject liquid onto the conveyed medium, the liquid ejection head including:
a nozzle plate including a plurality of nozzles from which liquid is ejected,
a first substrate facing the nozzle plate and in which a plurality of pressure chambers each communicating with a corresponding one of the nozzles are formed, and
a first vibrating plate on the first substrate, forming walls of the pressure chambers, and capable of vibrating to cause the liquid to be ejected from each of the nozzles independently, wherein
the first vibrating plate includes a central part at which the walls of the pressure chambers are formed and a pair of thin-wall parts by which the central part is sandwiched, a thickness of the thin-wall parts being smaller than that of the central part.

12. The liquid ejection apparatus according to claim 11, wherein
in a first direction along which the nozzles are arranged, a length of the first vibrating plate is shorter than a length of the first substrate and the nozzle plate.

13. The liquid ejection apparatus according to claim 11, wherein the liquid ejection head further includes a second vibrating plate on the first substrate,
the nozzles are arranged in a plurality of rows including first and second rows,
the first vibrating plate faces the nozzles in the first row, and
the second vibrating plate faces the nozzles in the second row.

14. The liquid ejection apparatus according to claim 11, wherein the liquid ejection head further includes a manifold plate in which a flow channel of the liquid is formed, and
the first vibrating plate is sandwiched between the first substrate and the manifold plate.

15. The liquid ejection apparatus according to claim 14, wherein the liquid ejection head further includes an adhesive layer between the manifold plate and the first substate at and outside each of the thin-wall parts of the first vibrating plate.

16. The liquid ejection apparatus according to claim 14, wherein
in a first direction along which the nozzles are arranged, a length of the first vibrating plate is shorter than a length of the manifold plate.

17. The liquid ejection apparatus according to claim 11, wherein
the nozzles are arranged in a first direction, and
each of the thin-wall parts extends in a second direction perpendicular to the first direction.

18. The liquid ejection apparatus according to claim 11, wherein
the first substrate and the first vibrating plate form a plurality of flow channels that communicate with the pressure chambers.

19. The liquid ejection apparatus according to claim 11, wherein the liquid ejection head includes a plurality of piezoelectric elements each configured to vary pressure in a corresponding one of the pressure chambers, and
each of the piezoelectric elements contacts the wall of the corresponding pressure chamber.

20. The liquid ejection apparatus according to claim 11, wherein the liquid ejection head further includes a second substrate between the nozzle plate and the first substate and forming flow channels through which the liquid can flow from common liquid chambers to the pressure chambers.
